(19) United States
(12) Patent Application Publication
(10) Pub. No.: US 2017/0078168 A1
(43) Pub. Date: Mar. 16, 2017

(54) Micro-Segmenting Networked Device Controller

(71) Applicant: Eunomic, Inc., McLean, VA (US)

(72) Inventors: James E. Harris, JR., McLean, VA (US); John C. Nelson, ARLINGTON, VA (US)

(73) Assignee: Eunomic, Inc., McLean, VA (US)

(21) Appl. No.: 15/264,687

(22) Filed: Sep. 14, 2016

Related U.S. Application Data
(60) Provisional application No. 62/218,768, filed on Sep. 15, 2015.

(51) Int. Cl. H04L 12/26; H04L 29/06; G06F 9/455

(52) U.S. Cl. CPC H04L 43/062; G06F 9/45558; H04L 63/20; H04L 63/10; H04L 63/1425; H04L 47/125

(57) ABSTRACT

A micro-segmenting networked controller device receives network traffic information from at least one micro-segmenting network devices. At least two of the micro-segmenting networked devices are communicatively coupled to at least one micro-segment within a network. The network is configured to communicatively couple at least two hosts. Traffic flow data is generated from the network traffic information. Network micro-segment traffic rules are augmented employing, at least in part, at least some of the traffic flow data. Authority is received to implement the rules from at least two entities each serving at least one of a multitude of roles. At least one of the micro-segmenting networked devices are programmed to control traffic flow within at least one micro-segment employing the network micro-segment traffic rules.

### CROSS-REFERENCE TO RELATED APPLICATIONS

This application claims the benefit of U.S. Provisional Application No. 62/218,768, filed Sep. 15, 2016, entitled “Micro-Segmenting Networked Device Controller,” which is hereby incorporated by reference in its entirety.

### BRIEF DESCRIPTION OF THE SEVERAL VIEWS OF THE DRAWINGS

FIG. 1 is a block diagram illustrating an example micro-segmenting network 100 according to some of the various embodiments of the present invention.

FIG. 2 is a flow diagram of an example process according to some of the various embodiments of the present invention.

FIG. 3A is a block diagram illustrating an example data plane switching network configuration.

FIG. 3B is a block diagram illustrating an example data plane switching network configuration.

FIG. 3C is a block diagram illustrating an example data plane switching network configuration.

FIG. 4 is an example block diagram illustrations of a system configured to microsegment a network according to some of the various embodiments of the present invention.

FIG. 5A is an example block diagram illustration of an integrated micro-segmenting network controller and data plane switch according to some of the various embodiments of the present invention.

FIG. 5B is an example block diagram illustration of a micro-segmenting network controller and data plane switch according to some of the various embodiments of the present invention.

FIG. 6 is an example illustration of a micro-segmenting network control screen in a learning-edit mode according to some of the various embodiments of the present invention.

FIG. 7 is an example illustration of a micro-segmenting network control screen in a learning-edit mode according to some of the various embodiments of the present invention.

FIG. 8 is an example illustration of a micro-segmenting network control screen in a monitor-view mode according to some of the various embodiments of the present invention.

FIG. 9 is an example illustration of a micro-segmenting network control screen in a heat map-view mode according to some of the various embodiments of the present invention.

FIG. 10 is an example illustration of a micro-segmenting network control screen in a heat map-view mode according to some of the various embodiments of the present invention.

FIG. 11 is an example illustration of a micro-segmenting network control screen in an advanced edit mode according to some of the various embodiments of the present invention.

FIG. 12 illustrates an example of a suitable computing system environment on which aspects of some embodiments may be implemented.

### DETAILED DESCRIPTION OF EMBODIMENTS

Some of the various embodiments of the present invention relate to micro-segmenting network security. A network may comprise a collection of devices designed to move data from one point to another. Many networks, networked components and resources are at risk from, for example, unauthorized access, misuse, modification, and overuse. Several of the current network security mechanisms do not provide a micro-level protection of network resources. Embodiments employ a micro-segmenting networked device controller to control communications between two devices using at least one micro-segment within a network. The micro-segmenting networked device controller may comprise a system that employs Software Defined Networking (SDN) to regulate network traffic according to rules established by, for example, a network administrator. Embodiments may comprise a level of control and visibility granted to the administrator through dynamic micro-segmentation.

A typical network switch may allow all traffic to pass within an established network segment, referred to as a Local Area Network (LAN) or a Virtual Local Area Network (VLAN). Aside from allowing the creation of VLANs (grouping blocks of network hosts together into segments), traditional switches may provide few security controls to an administrator, typically trusting all presented packet information (so long as it conforms with accepted networking standards), and rely on third party applications to provide visibility to network activity. According to some embodiments, a network switch may comprise a protocol configured to direct data through a network from one point to another. The protocol may comprise parameters identifying a device type, and a device role.

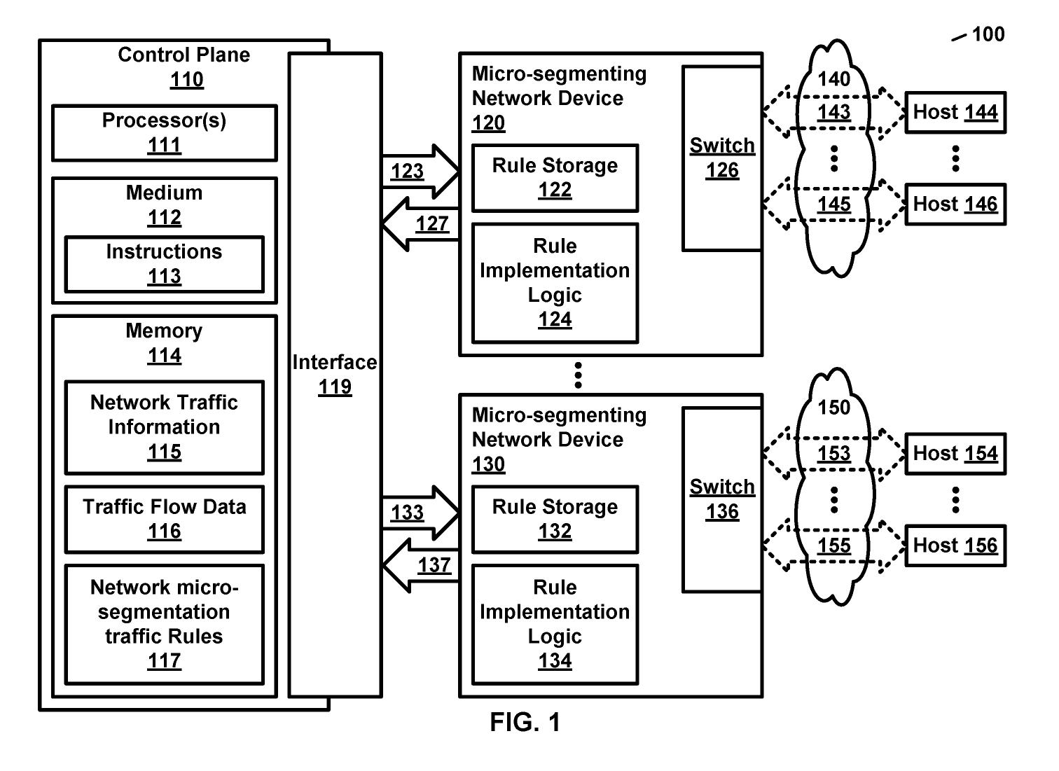

FIG. 1 is a block diagram illustrating a micro-segmenting network 100 according to some of the various embodiments of the present invention. The micro-segmenting network 100 may comprise a micro-segmenting network device controller 110, micro-segmenting networking devices (e.g. 120 . . . 130), and a plurality of hosts (e.g. 144 . . . 146 and 154 . . . 156).

According to an embodiment, the micro-segmenting network device controller 110 may comprise a processor 111, memory 114, at least one non-transitory tangible machine readable medium 112, and a communications interface 119. The memory 114 may be configured to store data, such as, but not limited to: network traffic information 114, traffic flow data 116 and network micro-segmentation traffic rules 117.

According to various embodiments, a micro-segment may be a subset of connections within a larger network (e.g. 140 . . . 150). According to various embodiments, micro-segments may comprise a point to point connection between two micro-segmenting networked devices. Additionally, according to various embodiments, micro-segments may comprise at least one sub-network within the network (e.g. 140 . . . 150). In yet another variation, may comprise a network zone. A network zone may comprise a fabric-based service that groups together hosts that require communication. A network zone may limit communications between devices only if they are members of the same zone. According to some embodiments, nodes may also be members of multiple zones.

According to an embodiment, the interface 119 may be configured to communicate with micro-segmenting networked devices (e.g. 120 . . . 130). According to various embodiments, the interface 119 may comprise, without limitation, at least one of the following: an Ethernet transceiver, a local area network controller, a wide area network controller, a fiber transceiver, a wireless transceiver, a wired transceiver, a computer bus transceiver, a local bus transceiver, a Wi-Fi transceiver, a virtual network interface, a network socket, a port, a computer port, a combination of the above, and/or the like.

According to various embodiments, the interface 119 may communicate comprising at least one of the following: a physical layer, a data link layer, an Internet protocol (IP), a network address, a combination of the above, and/or the like.

According to an embodiment, the micro-segmenting networked devices (e.g. 120 . . . 130) may be communicatively coupled to at least one micro-segment within a network (e.g. 140 . . . 150 respectively).

According to some of the various embodiments, micro-segmenting networked devices (e.g. 120 . . . 130) may comprise at least one network switch (e.g. 126, 136), network micro-segment traffic rule storage (e.g. 122, 132) and network micro-segment traffic rules implementation logic (e.g. 124, 134). The network micro-segment traffic rule storage (e.g. 122, 132) may be configured to hold at least a subset of the micro-segment traffic rules 117. The network micro-segment traffic rules implementation logic (e.g. 124, 134) may be configured to control at least one network switch (e.g. 126, 136) according to at least a subset of micro-segment traffic rules 117.

According to some of the various embodiments, micro-segmenting networked devices (e.g. 120 . . . 130) may comprise at least one of the following: a data diode (e.g. a device that constrains data flow to a single direction), a server, a compute node, a router, a switch, a firewall, a load balancer, a networking node, a storage node, a power node, a cooling node, a network appliance, a virtual appliance, a system hardware with network access, a hosted module within a system, a combination thereof, and/or the like. Multiple micro-segmenting networked devices (e.g. 120 . . . 130) may be integrated within a networking device. Similarly, Multiple micro-segmenting networked devices (e.g. 120 . . . 130) may be connected within a device via a motherboard, a cable, a combination thereof, and/or the like.

At least one of the micro-segmenting networked devices may comprise a switch and a switch control configured to control at least one of the following: the duration of a switch connection, the direction of a switch connection, a host to host connection, a switch port, the protocol of a switch connection, the socket port numbers used in the connection, the physical ingress and egress interfaces of the connection, a combination thereof, and/or the like. A switch may comprise a data connection. The switch control may be controlled, at least in part, by rule implementation logic (e.g. 124, 134). The rule implementation logic (e.g. 124, 134) may comprise discrete and/or programmable logic. Programmable logic may comprise one or more processors.

The network (e.g. 140 . . . 150) may be configured to communicatively couple at least two hosts (e.g. 144 . . . 146 and 154 . . . 156, respectively). According to various embodiments, the network (e.g. 140 . . . 150) may comprise, but is not limited to at least one of the following: a data network, a telecommunications network, a computer network, an intranet, the Internet, a packet-switched network, a wireless network, a cellular network, a wired network, a virtual local area network (vlan), a combination of the above, and/or the like.

According to an embodiment, the non-transitory tangible machine readable medium 112 may comprise instructions 113 configured to cause the processor(s) 111 to perform a process. The process may comprise interacting with micro-segmenting network devices (e.g. 120 . . . 130) over interface 119.

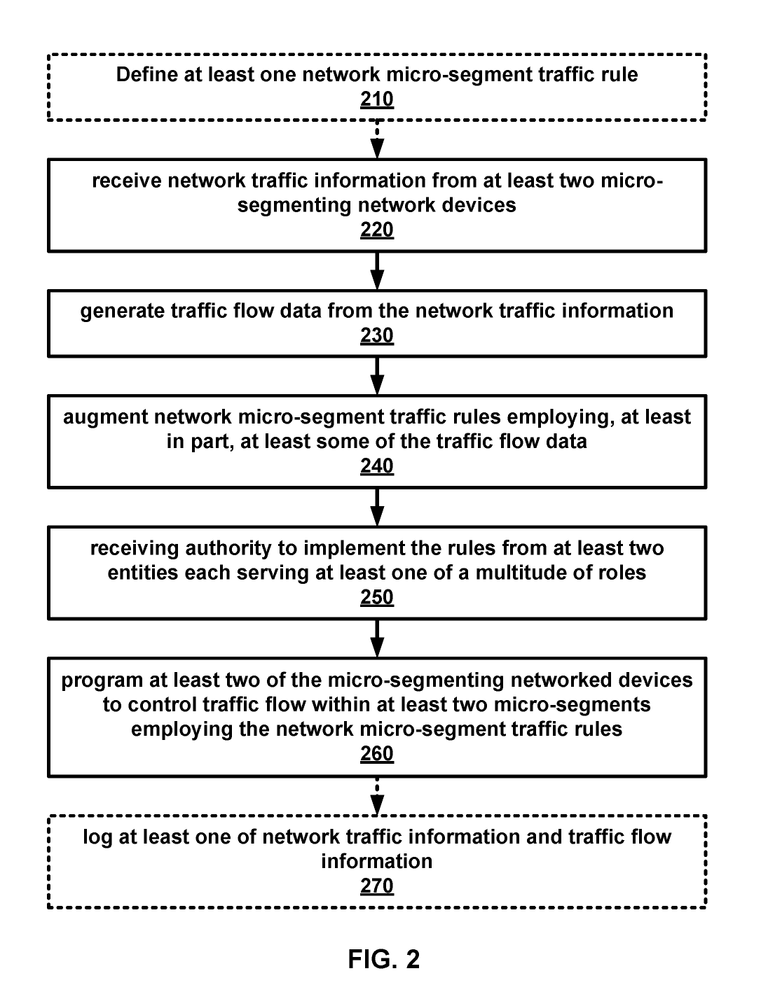

FIG. 2 is a flow diagram of an example process according to some of the various embodiments of the present invention. Embodiments may enforce network micro-segmentation traffic rules 117 in a network (e.g. 140 . . . 150). Network micro-segmentation traffic rules 117 may comprise, for example, without limitation, at least one of the following: a white list of allowable communications between at least two hosts, threat indicator logic, network micro-segmentation traffic rules modification logic, an indicator of compromise (IOC), an indicator of attack (IOA), a temporal network micro-segment traffic rule, a time limit for an untrusted device, a verification rule, a static rule, activity rules, a conditional rule (ex. If then else, scripting, state rules (state diagram)), an adaptive rule, (makes decisions based on past and predicted futures), a physical interface limiting rule, a combination of the above, and/or the like. A conditional rule may comprise, for example, an “If/then/else” statement, a script, state rules (e.g. as described in a state diagram), a combination thereof, and/or the like.

According to some of the various embodiments, network micro-segmentation traffic rules 117 may evaluate, for example without limitation, at least one of the following: duration of a communication, direction of a communication, a pack size, packet content, a watermark, the frequency of communications between at least two hosts, port rules, threat indicator logic, an indicator of compromise (IOC), an indicator of attack (IOA), a temporal network micro-segmentation traffic rule, the physical ingress and egress interface identifier, a combination thereof, and/or the like.

According to some of the various embodiments, network micro-segmentation traffic rules 117 may comprise at least one information technology device (IT) protection network micro-segment traffic rule. Such a rule may, for example, be configured to prevent specific traffic across specific micro-segments. Similarly, network micro-segment traffic rules may comprise at least one operational technology device (OT) protection network micro-segment traffic rule. An operational technology device (OT) protection network micro-segment traffic rule may be configured to prevent operational changes to the network switching, for example, by an entity unauthorized to make specific changes.

Network micro-segmentation traffic rules 117 may employ at least one of AND/OR logic and temporal logic configured to compare, for example without limitation, at least two of the following rule elements: a flow path, a frequency of flow originating from a single source, a frequency of flow destined for a single source, networked device information, an action source, an action, a physical ingress or egress interface identifier, a combination thereof, and/or the like.

Network micro-segmentation traffic rules 117 may comprise at least one predetermined network micro-segmentation traffic rule. Pre-determined network micro-segment traffic rule(s) may comprise a set of baseline rules configurable to be modified.

According to some of the various embodiments, network micro-segmentation traffic rule(s) 117 may be defined at 210. The network micro-segmentation traffic rule(s) 117 may be defined, for example, employing at least one of the following: a visual diagram, a script, a list, a combination thereof, and/or the like. The rules may be defined, for example, employing a descriptive language such as Snort, html, XML, a proprietary descriptive format, a combination thereof, and/or the like.

At 220, network traffic information 115 may be received from at least one of the micro-segmenting network devices (e.g. 120 . . . 130). According to various embodiments, network traffic information 115 may comprise, but is not limited to at least one of the following: a destination, a source, a function, a port number, a universally unique identifier, a virtual machine name, a hypervisor IP address, a group/community identifier, a port identifier, a port range identifier, a serial port range, a serial port identifier, a hostname, an internet protocol address, a protocol type, a service processor type, a media access control address (MAC) address, a physical ingress and egress interface identifier, a combination of the above, and/or the like. In some cases, network traffic information 115 may be learned from packet headers and/or the like. In some cases, network traffic information 115 may be learned from a micro-segmenting network device (e.g. 120 . . . 130) observing packets.

Traffic flow data 116 may be generated at 230 from the network traffic information 115. According to various embodiments, traffic flow data 116 may comprise, but is not limited to at least one of the following: network communication frequency information, network path information, network protocol information, a combination of the above, and/or the like. Traffic flow data 116 may comprise, but is not limited to at least one of the following: a destination, a source, a function, a port number, a universally unique identifier, a virtual machine name, a hypervisor IP address, a group/community identifier, a port identifier, a port range identifier, a serial port range, a serial port identifier, a hostname, an internet protocol address, a protocol type, a service processor type, a media access control address (MAC) Address, a physical ingress and egress interface identifier, a combination of the above, and/or the like. According to various embodiments, generating traffic flow data 116 from the network traffic information 115 may comprise calculating at least one of the following from the traffic flow data 116: network communication frequency information, network path information, network protocol information, a combination of the above, and/or the like.

At 240, the network micro-segmentation traffic rules 117 may be augmented employing, at least in part, at least some of the traffic flow data 116. For example, traffic flow data 116 may indicate an unusual amount of traffic between hosts (e.g. 144 . . . 146, 154 . . . 156) and augment the network micro-segmentation traffic rules 117 to protect the network from this potentially suspicious activity. Network micro-segmentation traffic rules 117 may also be augmented by human intervention after, for example, observing traffic flow data 116 of interest on a network diagram.

Authority may be received at 250 to implement the network micro-segmentation traffic rules 117 from at least two entities. Each of the two entities may serve at least one of a multitude of roles. According to various embodiments, an entity may comprise, but is not limited to at least one of the following: a management entity, an information technology (IT) entity, an operational technology (OT) entity, an operations entity, a security entity, an automated attack detection entity, a compromise detection entity, a combination of the above, and/or the like. According to various embodiments, a role may comprise, but is not limited to at least one of the following: a management role, an IT role, an OT role, an operations role, a security role, an automated attack detection role, a compromise detection role, an auditor role, a combination of the above, and/or the like.

At 260, at least one of the micro-segmenting networked devices (e.g. 120 . . . 130) may be programmed to control traffic flow within at least one micro-segment employing the network micro-segmentation traffic rules 117.

According to some of the various embodiments, network traffic information 115 and/or traffic flow data 116 may be logged at 270. Logging if data may be employed for many purposes such as, for example, future analysis and post event forensics and creation of new network micro-segmentation traffic rules 117.

At least some of the traffic flow data may be represented on a network micro-segment diagram. The augmenting of the network micro-segment traffic rules may be performed, according to some of the various embodiments, via a manipulation of the network micro-segment diagram. The detail of the network micro-segment diagram may be modified to allow an entity to drill down to various parts of the network.

According to some of the various embodiments, the network micro-segment diagram may present various aspects of the network, such as, for example, employing at least one of the following: a network topology, a micro-segmentation network topology, a network table, statistics, a combination thereof, and/or the like. Additionally, the network micro-segment diagram may be created the employing, at least in part, at least one of the following: a network description, a network device table, a network routing table, network traffic statics, a combination thereof, and/or the like.

To assist in analysis of a network, micro-segments on a network micro-segment diagram may color code and/or visually highlighting traffic statistics on the network micro-segment diagram. Such a technique may be referred to, for example, as heat mapping. In addition to color coding, other visual indicators may be employed such as line thickness, hatching, shading, a combination thereof, and/or the like.

The network micro-segment diagram may be created, at least in part, by discovering, via electronic communications over the network, properties for at least one of the micro-segmenting networked devices and hosts. The properties may be employed to build at least one of the following: at least part of a network micro-segment diagram, and/or at least part of the network micro-segment traffic rules.

Property discovery for at least some of the micro-segmenting networked devices and/or hosts may employ at least one of the following: listening to a network communication, listening to a DHCP request, interacting with a communications processor, interacting with a virtual machine hypervisor, interacting with a console server, interacting with a terminal server, interacting with an agent, interacting with a Configuration Management Database system, interacting with a data store system, interacting with a hosted module within a system, interacting with another infrastructure management device, a combinations thereof, and/or the like. Properties may comprise, for example, at least two of the following: a universally unique identifier, a virtual machine name, a hypervisor IP address, a group/community identifier, a port identifier, a port range identifier, a serial port range, a serial port identifier, a hostname, an internet protocol Address, a protocol type, a service processor type, a media access control address (MAC) Address, a physical ingress and/or egress interface identifier, a combination thereof, and/or the like.

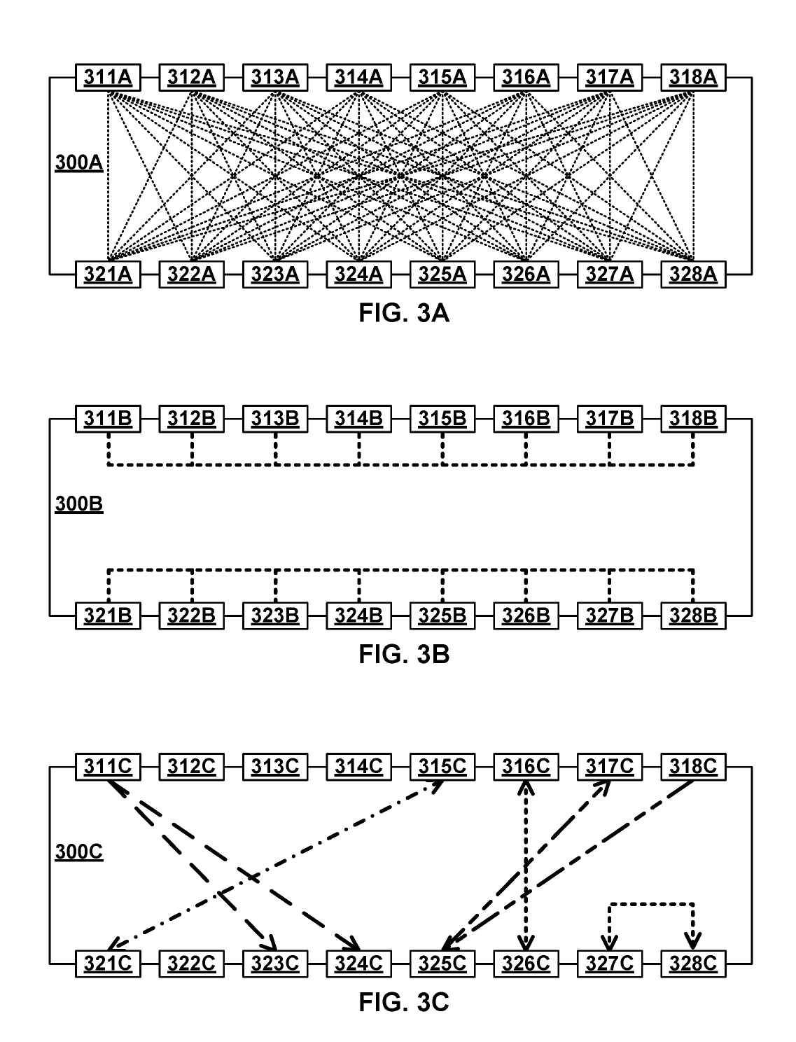

FIG. 3A illustrates an example of a prior art network switch 300A with a multitude of first ports (311A, 312A, 313A, 314A, 315A, 316A, 317A, and 318A) and a multitude of second ports (321A, 322A, 323A, 324A, 325A, 326A, 327A, and 328A). As illustrated, packets may be directed with minimal security controls between any of the first ports (311A, 312A, 313A, 314A, 315A, 316A, 317A, and 318A) and any of the second ports (321A, 322A, 323A, 324A, 325A, 326A, 327A, and 328A).

FIG. 3B illustrates another prior art network switch 300B configured with a first segment and a second segment. The first segment comprises ports (311B, 312B, 313B, 314B, 315B, 316B, 317B, and 318B) and the second segment comprises ports (321B, 322B, 323B, 324B, 325B, 326B, 327B, and 328B). As illustrated, packets may be directed with minimal security controls between any of the firsts within a segment. So, for example, packets may be directed with minimal security controls between any of the ports (311B, 312B, 313B, 314B, 315B, 316B, 317B, and 318B) in the first segment. Likewise, packets may be directed with minimal security controls between any of the ports (321B, 322B, 323B, 324B, 325B, 326B, 327B, and 328B) in the second segment.

Example FIG. 3C illustrates an embodiment of a zero trust micro-segmenting networked switch 300C configured to, for example: disallow traffic not expressly allowed by an administrator (e.g. a “Flow White Listing”) and enforce rules of good behavior. The rules of good behavior may be defined by an administrator, a trusted authority, and/or the like. The micro-segmenting networked switch may also enforce security rules such as “separation of duty rules,” by requiring changes to baseline rules be approved by a user with a supervisory role, effectively reducing the risk of human error or deliberate insider threat. Changes may be logged for audit purposes. Additionally, information may be provided to provide the administrator with an ongoing, visual representation of the state of the network.

As illustrated in FIG. 3C, micro-segmenting networked switch 300C comprises a multitude of ports (311C, 312C, 313C, 314C, 315C, 316C, 317C, 318C, 321C, 322C, 323C, 324C, 325C, 326C, 327C, and 328C). The switch may be configured to limit traffic according to micro-segment the network paths touching the micro-segmenting networked switch 300C ports (311C, 312C, 313C, 314C, 315C, 316C, 317C, 318C, 321C, 322C, 323C, 324C, 325C, 326C, 327C, and 328C) according to rules of good behavior. So, for example, packets paths may be constrained to: (1) from port 311C to port 323C; (2) from port 311C to port 324C; (3) between port 315C and port 321C; (4) between port 316C and port 326C; (5) between port 317C and port 325C; (6) from port 318C to port 325C; and (7) between port 327C and 328C. All other traffic may be disallowed. Even among these allowable routes, rules may be enforced that may disallow packets that do not meet other rules, such as traffic from a specific device (e.g. a printer) to another specific device (e.g. a server).

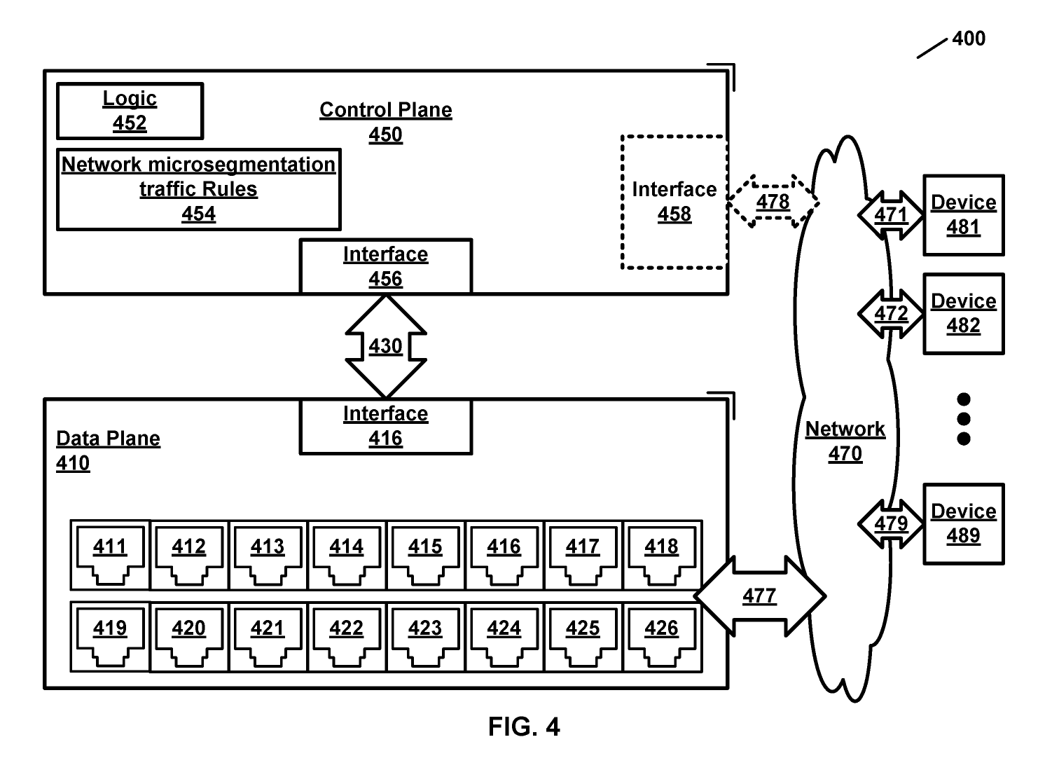

Example FIG. 4 is an illustration of a system 400 configured to microsegment a network (or part thereof). The system may comprise a control plane 450 in communication with a data plane 410.

A data plane (e.g. 410) may comprise a communications switching network. For example, data plane 410 may comprise a programmable network switch with a multitude of ports (e.g. 411, 412, 413, 414, 415, 416, 417, 418, 419, 420, 421, 422, 423, 424, 425, and 426). The data plane 410 and the control plane 450 may communicate via interfaces 456 and/or 416 over communications channel 430. Communications channel 430 may comprise a wired and/or wireless communications channel.

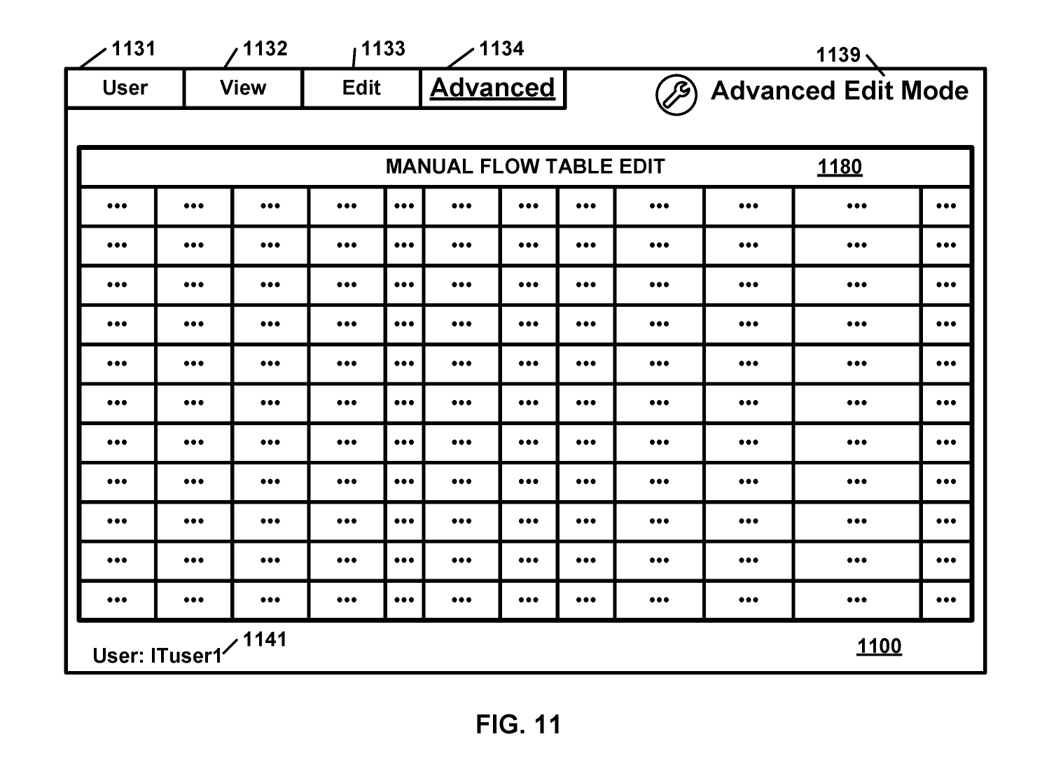

A data plane (e.g. 410) may comprise part of the switch architecture that decides what to do with packets arriving on an inbound interface. For example, a data plane may comprise a table in which a router looks up the destination address of the incoming packet and retrieves the information necessary to determine the path from the receiving element, through the internal forwarding fabric of the router, and to the proper outgoing interface(s). An example of such as table is illustrated in FIG. 11.

In certain cases, a table may specify that a packet is to be discarded. In such cases, the router may return an ICMP “destination unreachable” or other appropriate code. Some security policies, however, may dictate that the router should drop the packet silently, in order that a potential attacker does not become aware that a target is being protected.

An incoming forwarding element may also decrement the time-to-live (TTL) field of the packet, and, if the new value is zero, discard the packet. While the Internet Protocol (IP) specification indicates that an Internet Control Message Protocol (ICMP) Time exceeded message should be sent to the originator of the packet (i.e. the node indicated by the source address), the router may be configured to drop the packet silently (again according to security policies).

Depending on the specific router implementation, a table in which the destination address is looked up may be employed (e.g. routing table also known as the routing information base, RIB), or a separate forwarding information base (FIB) that is populated (i.e., loaded) by a routing control plane, but used by the forwarding plane for look-ups at much higher speeds. Before or after examining the destination, other tables may be consulted to make decisions to drop the packet based on other characteristics, such as the source address, the IP protocol identifier field, or Transmission Control Protocol (TCP) or User Datagram Protocol (UDP) port number.

Outgoing interface(s) of a data plane may encapsulate a packet in an appropriate data link protocol. Depending on the router software and its configuration, functions, usually implemented at the outgoing interface(s), may set various packet fields, such as the DSCP field used by differentiated services.

As described, according to various embodiments, the passage from an input interface directly to an output interface may comprise processing, such as segmentation and/or encryption. This processing may comprise forwarding and/or processing decisions based on rules and higher-layer information, such as a Web URL contained in the packet payload.

Data plane ports (e.g. 411, 412, 413, 414, 415, 416, 417, 418, 419, 420, 421, 422, 423, 424, 425, and 426) may be communicatively connected to various devices (e.g. device 481, 482 . . . 489) over a network 470. Network 470 may comprise a multitude of interconnected communications networks via combinations of interfaces (e.g. 477, 471, 472 . . . 479) through, for example: the Internet, an intranet, a connection to the Internet, a private cloud, interconnected data centers, a multi-nodal network, two or more computing devices connected using a Virtual Private Network, an on premise network, a combination thereof, and/or the like.

The control plane may comprise logic 452 configured to control data planes (e.g. 410) to enforce switching rules. Embodiments of logic 452 may comprise programmable hardware. Examples of programmable hardware may comprise: computers, microcontrollers, microprocessors, application-specific integrated circuits (ASICs), field programmable gate arrays (FPGAs), and complex programmable logic devices (CPLDs). Programmable hardware may operate in combination with instructions stored on non-transitory tangible machine readable memory medium(s) 454.

Embodiments may comprise an SDN (software defined networking) controller, a software application that establishes and decommissions network flows—essentially creating a table of permitted connections between different hosts connected to different Ethernet (or other network physical interface) ports on a switch. The functions of the controller may comprise a multitude of capabilities.

According to some of the various embodiments, a control plane (e.g. 450) may enabling strong authentication, such as multi-factor authentication for controller user roles to protect the network controller from tampering or unauthorized changes to the network. According to some of the various embodiments, a control plane (e.g. 450) may provide visibility to connection states of data plane(s) (e.g. 410) by graphically displaying connections between hosts, rich metadata about the types of connections in use (such as protocol), and the relative intensity of network traffic along those connections (“Heat Mapping”). This visibility may be tailored according the needs and privileges of individual user roles.

According to some of the various embodiments, a control plane (e.g. 450) may listen to, and learn the way devices are attempting to communicate. This communication information may be presented to an entity such as an administrator to assist with network setup and the identification of devices. According to some of the various embodiments, a control plane (e.g. 450) may Attempt to automatically identify the types of devices on the network by inspecting their network traffic profile. This identification may, for example comprise comparison of device characteristics with profiles of known devices.

According to some of the various embodiments, a control plane (e.g. 450) may enable an entity with a role such as, for example, an administrator—through a graphical user interface (GUI)—to use line drawings and other visual tools to build complex flow control tables. This graphical management may perform network traffic manipulation without the need for commands or scripts. This graphical management may be employed to microsegment a network.

According to some of the various embodiments, a control plane (e.g. 450) may comprise a scripting capability for authorized entities such as, for example, an administrator. This scripting capability may be employed to script rules (e.g. micro-segmentation rules) to govern network traffic dynamically. The rules may constrain flows. For instance, some specific flows may be limited to a given duration based upon the occurrence of another event. For example, according to a given communications protocol defined in the system, if Host 1 communicates with Host 2, the controller may open a limited-duration back-channel from Host 2 to Host 1 to allow a reply.

According to some of the various embodiments, a control plane (e.g. 450) may enforce security rules through separation of duties, requiring two or more user roles (e.g., a system administrator role and a manager role) to approve changes to the network configuration. In such a case, an alert may be generated to report efforts to alter the network otherwise (such as, for example, through manipulating cables). According to some of the various embodiments, a control plane (e.g. 450) may be configured to allow coordination of requests and permissions between the various defined user roles. Additionally, a control plane (e.g. 450) may be configured to alert an entity with an administrator role and/or other user roles to report attempts at, for example, bad behavior by specific and/or any host on the network, and/or any physical attempts to tamper with the network.

According to some of the various embodiments, a control plane (e.g. 450) may be configured to maintain updateable lists of known bad behaviors (signatures) to alert possible compromises or failures. Additionally, control plane (e.g. 450) may be configured to log accesses, changes to the network flow tables, and/or exceptions and/or errors. This logging may be employed for audit and debugging purposes.

Devices 481, 482 . . . 489 (also referred herein as hosts) may comprise networked devices such as IT and/or OT devices. A networked device (e.g. 481, 482 . . . 489) may comprise a machine or component that is communicatively connected to a network (e.g. 470). Examples of networked devices may comprise peripheral devices and non-peripheral device. Examples of peripheral devices comprise disk drives, printers, displays, mice, and modems. Examples of non-peripheral devices comprise IT devices and computing equipment. An IT device is an “Information Technology” device related to computing technology, comprising, but not limited to: data center devices, networking devices, hardware devices, software operating in combination with a hardware IT device, Internet devices, and/or the like. Some IT devices may employ virtual devices operating on specially configured hardware. Additional examples of IT devices comprise compute nodes, networking nodes, storage nodes, power nodes, cooling nodes, combinations thereof, and/or the like. Computing equipment may comprise smart devices, computers, connected sensors and actuators, combinations thereof, and/or the like. An OT device “Operational Technology” device may comprise hardware and/or software configured to detect or cause a change through the monitoring and/or control of physical devices, processes and events. To this end, an OT device may comprise sensors and/or actuators connected to physical devices, e.g. mechanical, solenoids, pumps, thermostats, bio-medical sensors, “smart grid” devices, combinations thereof, and/or the like. Examples of systems that may comprise OT devices comprise, without limitation, supervisory control and data acquisition (SCADA) systems, smart grid systems, manufacturing systems, smart homes, combinations thereof, and/or the like.

Some network connected devices may comprise virtual devices. Examples of virtual devices comprise, but are not limited to: virtual firewalls, virtual intrusion detection devices, virtual routers, virtual, gateways, virtual servers, virtual switches, virtual processors, combinations thereof, and/or the like. A virtual device may employ a software virtual device driver operating on a properly configured hardware computing device that emulates hardware and other devices so that multiple applications may, for example, access hardware interrupt channels, hardware resources and memory without causing conflicts. Computer hardware may require communication and control processes for devices and/or hardware components to access each other in a controlled manner. These processes may be defined as device drivers, which may comprise code that an application may employ to access hardware or external software resources. Some example virtual devices may be configured for use in multitasking operating systems. In such an example, a device driver may be controlled by an operating system's virtual device driver manager and shared by applications running within that kernel. A virtual device driver may pass interrupt and memory requests through the kernel, which in turn may allocate resources as required.

Some network connected devices may comprise an agent. An agent may comprise a computer program that acts for a user or other program in a relationship of agency, which derives from the Latin agere (to do): an agreement to act on one's behalf. Such “action on behalf of” implies the authority to decide which, if any, action is appropriate. Some agents may comprise, but are not limited to: intelligent agents (in particular exhibiting some aspect of artificial intelligence, such as learning and reasoning), autonomous agents (capable of modifying the way in which the agent achieves objectives), distributed agents (being executed on physically distinct computers), multi-agent systems (distributed agents that do not have the capabilities to achieve an objective alone and thus must communicate), and mobile agents (agents that can relocate their execution onto different processors).

Some of the various data planes (e.g. 410) may comprise (in combination with configured hardware) and/or physical IT devices configured to switch network traffic between devices (e.g. 481, 482 . . . 489). Various IT devices (e.g. 481, 482 . . . 489) may employ various connections and protocols.

A protocol may comprise a system of digital rules for the exchange of data within or between computers. The rules may define format(s) for exchanging messages where some messages are configured to elicit a response from a range of possible responses pre-determined for that particular situation. A protocol may define the syntax, semantics, and synchronization of communication. Some protocols may comprise a set of digital rules that interface one protocol with another protocol. For example, a protocol may convert a legacy protocol to a newer protocol. This could allow a newer system to communicate with an older system. Similarly, another example protocol may be configured to interface devices that have incompatible protocols. Some specified behaviors may be independent of how an interface is implemented. A protocol may be implemented as hardware, software, or both. Some of the various communications protocols may be implemented according to one or more technical standards from organizations such as, but not limited to, the International Organization for Standardization (ISO), the International Telecommunications Union (ITU), the Institute of Electrical and Electronics Engineers (IEEE), and the Internet Engineering Task Force (IETF).

IT device information may comprise, but is not limited to, at least two of the following: a universally unique identifier, a virtual machine name, a hypervisor IP address, a group and/or community identifier, a port identifier, a port range identifier, a serial port range, a serial port identifier, a hostname, an IP Address, a protocol type, a service provider type, a MAC Address, a hierarchical organization, a combination thereof, and/or the like.

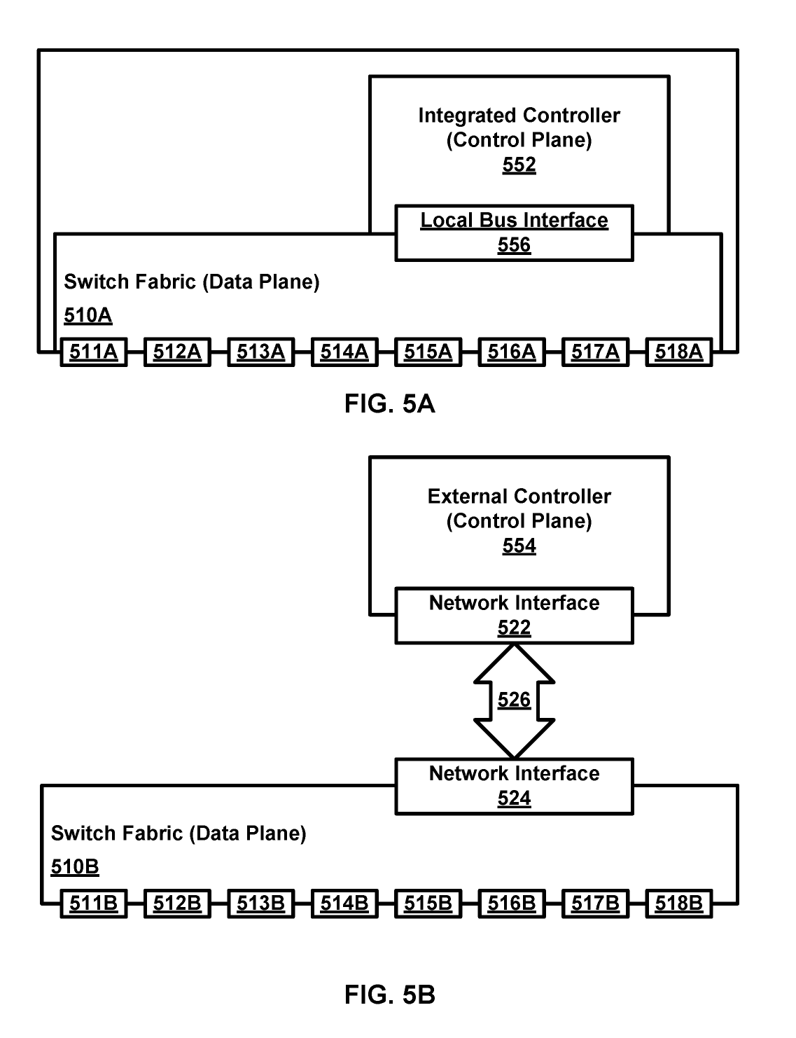

FIG. 5A is an example block diagram illustration of an integrated micro-segmenting network controller 552 and data plane switch 510A communicatively connected over a communications bus (e.g. local bus interface 556) according to some of the various embodiments of the present invention. In such an embodiment, the controller 552 and data plane switch 510A may be physically packaged in the container. According to some embodiments, the controller 552 and data plane 510 may be part of the same circuit board. In another embodiment, the control plane may plug into the data plane. In yet another embodiment, the data plane 510A may be plugged into the controller 552. In yet other embodiments, data plane 510A and controller 552 may be connected over a communications cable. The local bus interface may be serial and/or parallel based. The data plane 510A may comprise a multitude of switchable ports (e.g. 511A, 512A, 513A, 514A, 515A, 516A, 517A, and 518A).

FIG. 5B is an example block diagram illustrating an embodiment where a micro-segmenting network controller 554 and data plane switch 510B are connected over a communications channel 526 via network interfaces 522 and 524 respectively. This embodiment may allow a configuration where the micro-segmenting network controller 554 and data plane switch 510B are remotely located. The communications channel 526 (supported by network interfaces 522 and 524) may comprise wireless and wired communications channels, examples of which have been mentioned earlier.

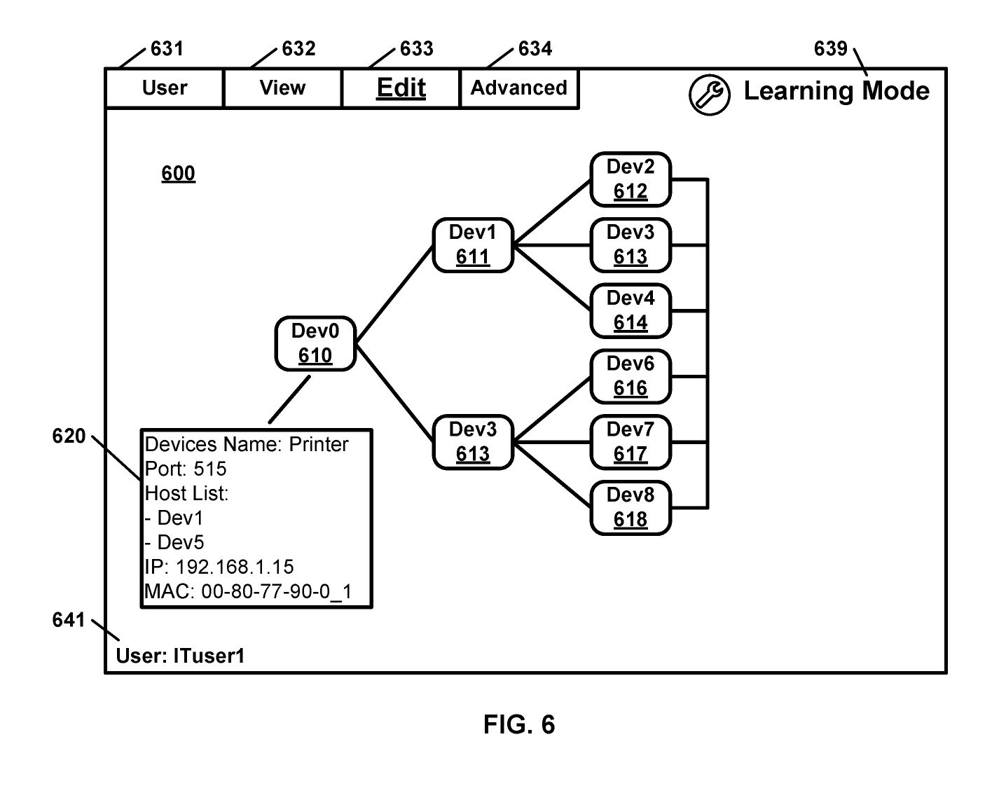

FIG. 6 is an example illustration of a micro-segmenting network control graphical user interface (GUI) screen 600 in a learning-edit mode according to some of the various embodiments of the present invention. This example GUI has a multitude of menu items: User 631, View 632, Edit 633 (currently selected), and Advanced 634. A mode indicator 639 may indicate the current GUI mode, which in this example is “Learning Mode.” A Role indicator 641 may indicate the current role of the entity currently logged into the GUI, which in this example is “ITuser1.” It is anticipated that the micro-segmenting network control graphical user interface (GUI) screen 600 may be implemented according to various embodiments with various menu and indicator elements.

In this example embodiment, the micro-segmenting network controller GUI is in a “learn” mode, while the micro-segmenting network controller attempts to map out the devices and network connections on a network data plane. In this mode, the network plane may be operating passively as a traditional switch. The controller may create a representation of the devices (e.g. 610, 611, 612, 613, 614, 615, 616, 617, and 618) it found, and the paths over which they tried to communicate. According to some of the various embodiments, the paths and/or devices (e.g. 610, 611, 612, 613, 614, 615, 616, 617, and 618) may be arranged an arbitrary manner, and labeled with generic names.

In this example, the controller suspects “Dev0” (610) is a printer, and may fill in suggested information 620 for the administrator (ITUser1 641) to accept or change. Other devices (e.g. 611, 612, 613, 614, 615, 616, 617, and 618) may be arranged and connected according to a process ranking devices by suspected importance (such as traffic generated or received, or number and degree of connections). Once the devices are detected, a system administrator may name them, rearrange them, and microsegment their access, as described, for example, in FIG. 2.

Various elements on the GUI may also be selected to present additional information. So, for example, in this example illustration, information window 620 relating to Dev0 610 may be presented in response Dev0 610 being selected by a user of the GUI.

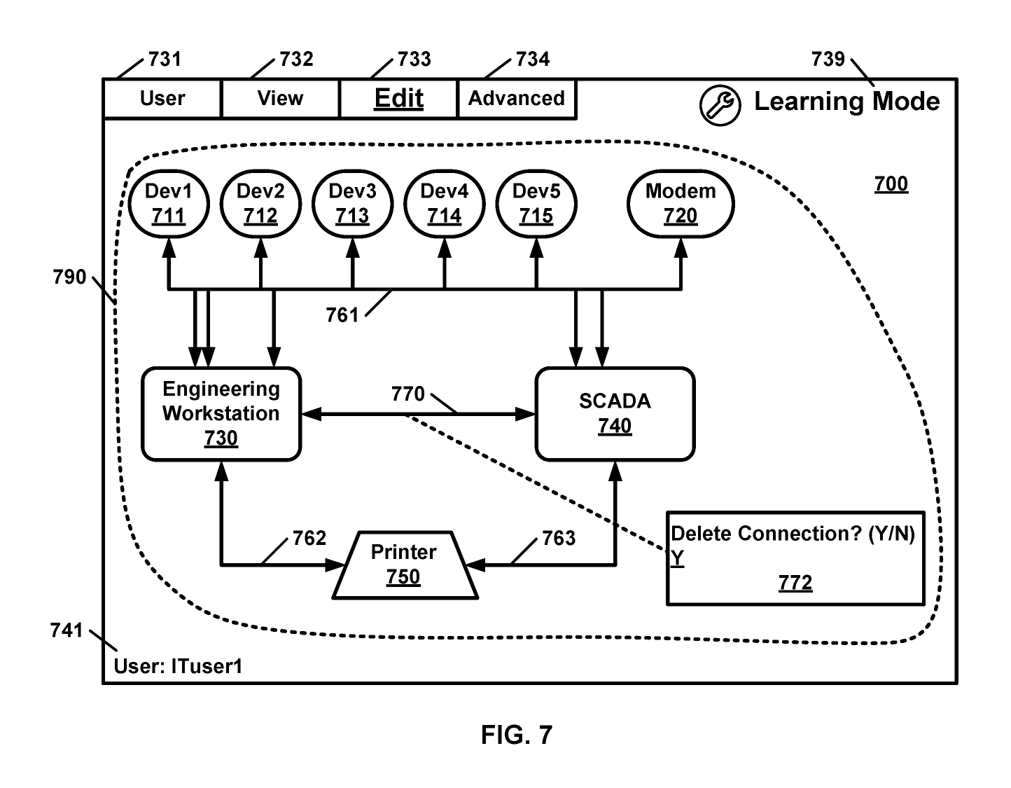

FIG. 7 is an example illustration of a micro-segmenting network control GUI screen 700 in a learning-edit mode according to some of the various embodiments of the present invention. This example GUI has a multitude of menu items: User 731, View 732, Edit 733 (currently selected), and Advanced 734. A mode indicator 739 may indicate the current GUI mode, which in this example is “Learning Mode.” A Role indicator 741 may indicate the current role of the entity currently logged into the GUI, which in this example is “ITuser1.” It is anticipated that the micro-segmenting network control graphical user interface (GUI) screen 700 may be implemented according to various embodiments with various menu and indicator elements.

The operator's visual representations 790 may be converted into flow control tables and other instructions to turn the visual image into a network structure. As illustrated in this example, the visual representation 790 comprises networked devices: device 1 711, device 2 712, device 3 713, device 4 714, device 5 715, modem 720, engineering workstation 730, supervisory control and data acquisition system (SCADA) 740 and printer 750. 616, 617, and 618. The networked devices are connected by segments 761, 770, 762, and 763.

A user with, for example, an administrator roll, may define allowed modes of communication, eliminating activity that could be dangerous, or simply cause unwanted network traffic, combinations thereof, and/or the like. This micro-segmenting process may allow fine control of the network, limiting, for example, traffic down to the connection, direction, protocol, combinations thereof, and/or the like. Segments can be indicated to visually demonstrate at-a-glance what protocols are permitted on a microsegment. Indications may comprise, for example, color coded, line thicknesses, hashing, dashing, combinations thereof, and/or the like. For example, as shown, an option window 772 is presented to allow ITuser 1 741 microsegment the network by providing an option to delete connection 770.

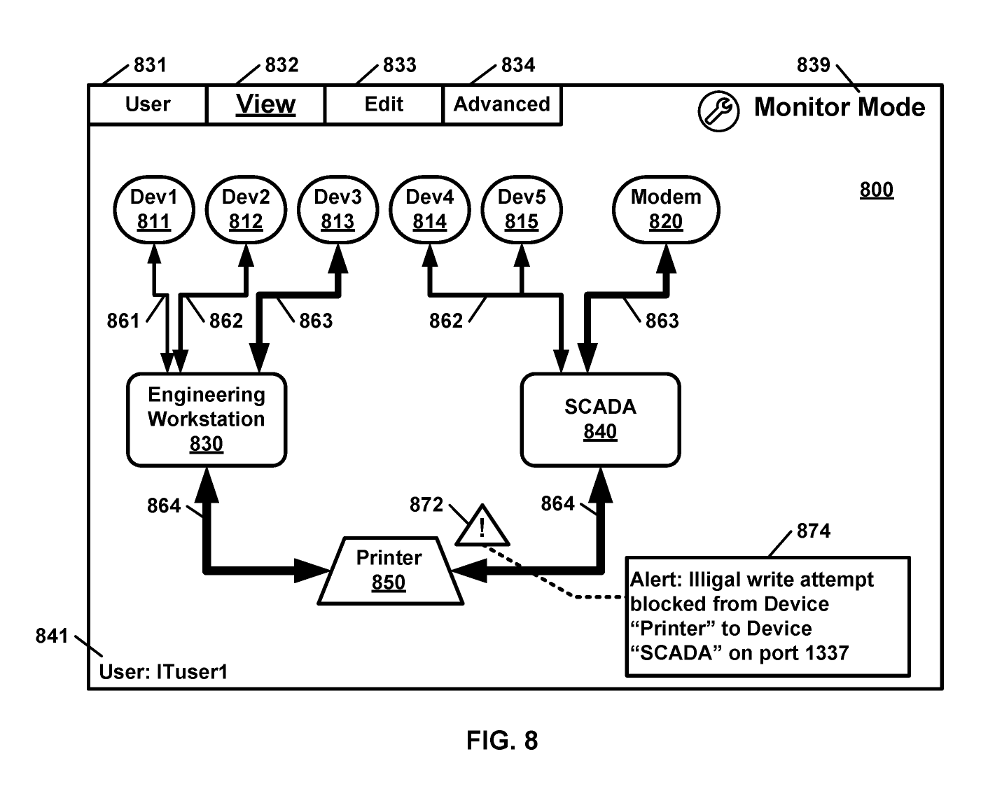

Once the microsegments are established, the controller may go into a monitoring mode to report potentially bad behavior based on signature rules of the controller, as illustrated in example FIG. 8. and/or based on alerts received out of band from other security devices in the network

FIG. 8 is an example illustration of a micro-segmenting network control GUI screen 800 in a monitor-view mode according to some of the various embodiments of the present invention. This example GUI 800 has a multitude of menu items: User 831, View 832 (currently selected), Edit 833 and Advanced 834. A mode indicator 839 may indicate the current GUI mode, which in this example is “Monitor Mode.” A Role indicator 841 may indicate the current role of the entity currently logged into the GUI, which in this example is “ITuser1.” It is anticipated that the micro-segmenting network control graphical user interface (GUI) screen 800 may be implemented according to various embodiments with various menu and indicator elements.

In this example, the GUI 800 shows a visual representation of at least part of a network comprising networked devices: device 1 811, device 2 812, device 3 813, device 4 814, device 5 815, modem 820, engineering workstation 830, supervisory control and data acquisition system (SCADA) 840 and printer 850. The networked devices are connected by visually indicated micro-segments 861, 862, 863, and 864). Each of these segments are visually indicated with a visual differentiator. In this case, the visual differentiator is the thickness of the lines. In other embodiments, the visual differentiator may comprise, for example, color, highlighting, dashing, hatching, combinations thereof, and/or the like.

In this example, the controller has detected an attempt to access the “SCADA” host 840 from printer 850 using port 1337, the “Leet” port often used by hackers. That type of behavior spans an immediate visual alert 872 (with details shown in window 874), even though the traffic was not passed (not being permitted, or, “white listed” in the flow table). Alerts may be customized, as needed, since most traffic is blocked automatically, and may not warrant an alert.

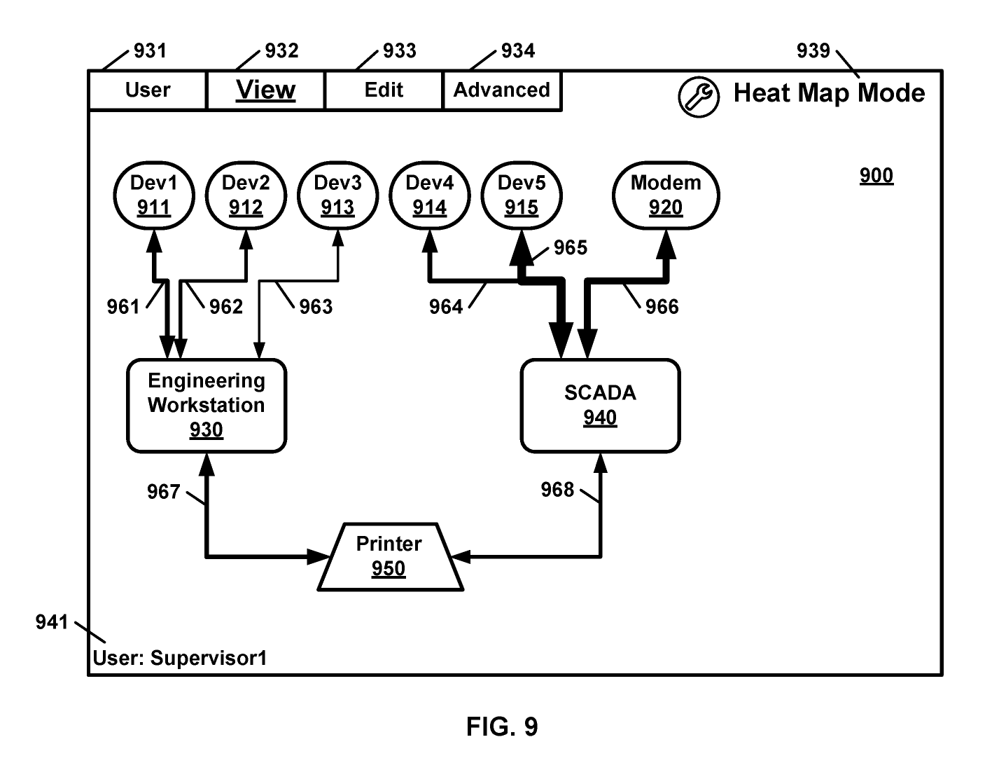

Another visualization tool that may be employed by embodiments of a micro-segmenting network controller is the “Heat Map” mode. As seen in FIG. 9, a heat map may graphically demonstrate which flows are “running hot” (i.e., significant traffic in excess of expected). The gradient shading of a flow and/or device may allow a user to see which device is generating most of that traffic on the flow.

FIG. 9 is an example illustration of a micro-segmenting network control GUI screen 900 in a heat map-view mode according to some of the various embodiments of the present invention. This example GUI 900 has a multitude of menu items: User 931, View 932 (currently selected), Edit 933 and Advanced 934. A mode indicator 939 may indicate the current GUI mode, which in this example is “Heat Map Mode.” A Role indicator 941 may indicate the current role of the entity currently logged into the GUI, which in this example is “Supervisor1.” It is anticipated that the micro-segmenting network control graphical user interface (GUI) screen 900 may be implemented according to various embodiments with various menu and indicator elements.

In this example, the GUI 900 shows a visual representation of at least part of a network comprising networked devices: device 1 911, device 2 912, device 3 913, device 4 914, device 5 915, modem 920, engineering workstation 930, supervisory control and data acquisition system (SCADA) 940 and printer 950. The networked devices are connected by visually indicated segments 961, 962, 963, 964, 965, 966, 967 and 968). Segments are visually indicated with a visual differentiator. In this case, the visual differentiator is the thickness of the lines. In other embodiments, the visual differentiator may comprise, for example, color, highlighting, dashing, hatching, combinations thereof, and/or the like.

In the example, the management user role (Supervisor1) has observed that the flow 965 from “Dev5” 915 to “SCADA” 940 is unusually active, and can see that the “Dev5” 915 side is generating most of that traffic. Depending on the set-up, this role may not want or need more technical detail, but may coordinate with a more technical user to investigate.

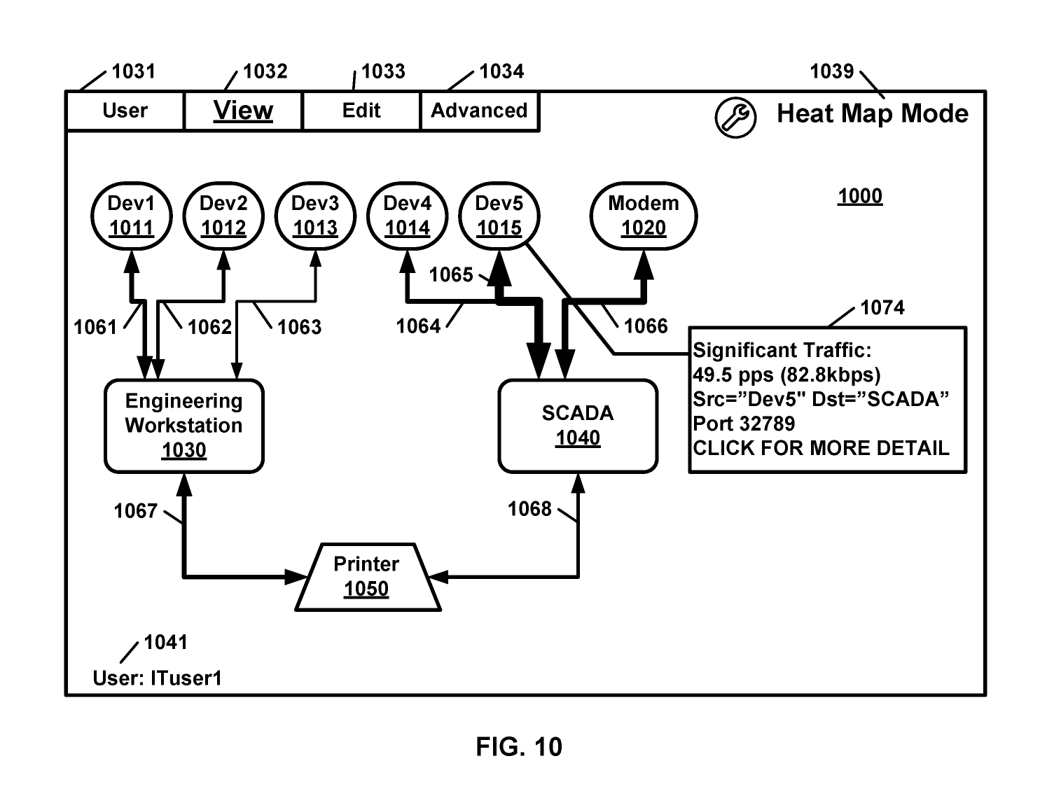

FIG. 10 is an example illustration of a micro-segmenting network control GUI screen 1000 in a heat map-view mode according to some of the various embodiments of the present invention. This example GUI 1000 has a multitude of menu items: User 1031, View 1032 (currently selected), Edit 1033 and Advanced 1034. A mode indicator 1039 may indicate the current GUI mode, which in this example is “Heat Map Mode.” A Role indicator 1041 may indicate the current role of the entity currently logged into the GUI, which in this example is “ITuser1.” It is anticipated that the micro-segmenting network control graphical user interface (GUI) screen 1000 may be implemented according to various embodiments with various menu and indicator elements.

In this example, the GUI 1000 shows a visual representation of at least part of a network comprising networked devices: device 1 1011, device 2 1012, device 3 1013, device 4 1014, device 5 1015, modem 1020, engineering workstation 1030, supervisory control and data acquisition system (SCADA) 1040 and printer 1050. The networked devices are connected by visually indicated segments 1061, 1062, 1063, 1064, 1065, 1066, 1067 and 1068). Segments are visually indicated with a visual differentiator. In this case, the visual differentiator is the thickness of the lines. In other embodiments, the visual differentiator may comprise, for example, color, highlighting, dashing, hatching, combinations thereof, and/or the like.

As illustrated in this example, “ITUser1” (indicated by 1041) has been requested to investigate, and has been presented with greater technical detail. ITUser1 (indicated by 1041) may obtain much more specific information (e.g. as illustrated in information window 1074), and take actions to remediate the potential problem.

FIG. 11 is an example illustration of a micro-segmenting network control screen in advanced edit mode according to some of the various embodiments of the present invention. This example GUI 1100 has a multitude of menu items: User 1131, View 1132, Edit 1133 and Advanced 1134 (currently selected). A mode indicator 1139 may indicate the current GUI mode, which in this example is “Advanced Edit Mode.” A Role indicator 1141 may indicate the current role of the entity currently logged into the GUI, which in this example is “ITuser1.” It is anticipated that the micro-segmenting network control graphical user interface (GUI) screen 1100 may be implemented according to various embodiments with various menu and indicator elements.

In this example, the GUI 1100 shows a visual representations of a manual flow table 1180 for at least part of a network. If an entity (e.g. ITuser1 as indicated by 1141) has permissions to make advanced changes to the network, the Advanced menu may allow manual changes to the network instructions, dynamically micro-segmenting the network in Real Time. The advanced mode may enable editing of raw network flow detail(s) in the manual flow table 1180, including source and destination addressing, Ethernet port numbers, timeout length, priority, combinations thereof, and/or the like.

According to some of the various embodiments, another feature (not pictured) of the Advanced mode may permit visual algorithmic scripting of flow control, predicating the creation or decommissioning of flows on certain triggers and rules defined by the administrator (dynamic micro-segmentation).

Some of the various embodiments may be implemented in a stand-alone “smart” appliance with sufficient processing power and multiple network ports. Alternative embodiments may be virtualized, or exist on a standalone server controlling one or more generic SDN switches. The controller may be configured to allow for integration with other third party applications and virtual appliances (such as Intrusion Prevention Systems or Virtual Firewalls) to provide additional functionality, as needed.

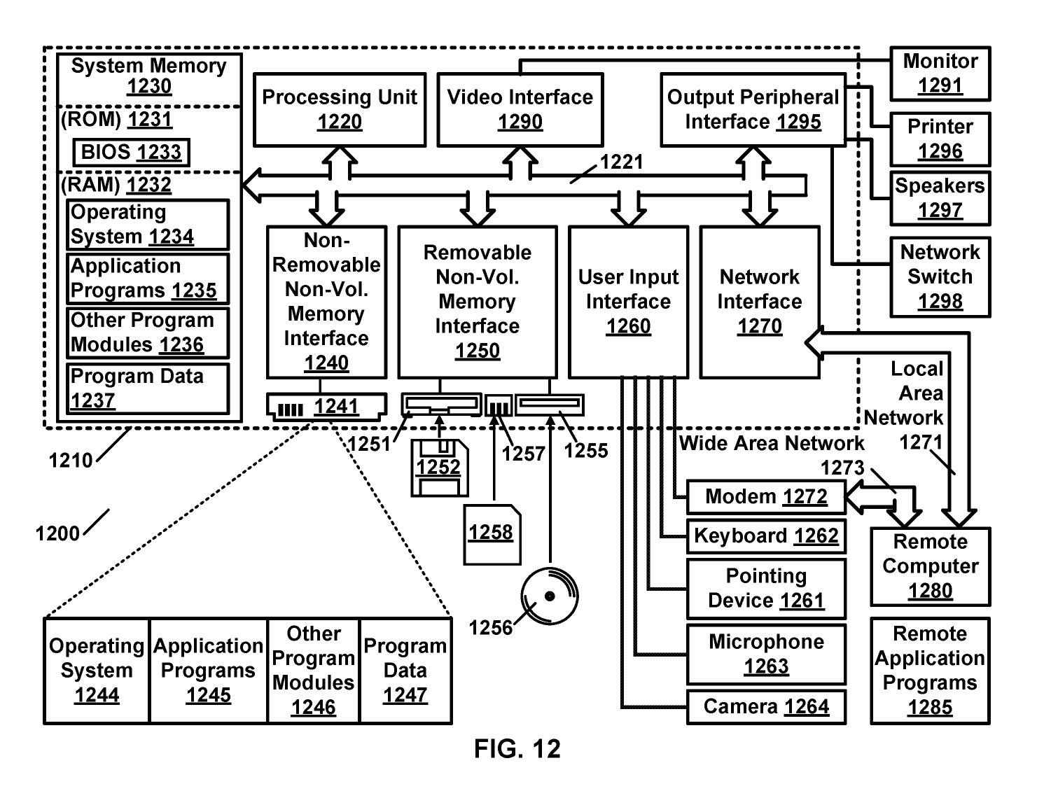

FIG. 12 illustrates an example of a suitable computing system environment 1200 on which aspects of some embodiments may be implemented. The computing system environment 1200 is only one example of a suitable computing environment and is not intended to suggest any limitation as to the scope of use or functionality of the claimed subject matter. Neither should the computing environment 1100 be interpreted as having any dependency or requirement relating to any one or combination of components illustrated in the exemplary operating environment 1200.

Embodiments are operational with numerous other general purpose or special purpose computing system environments or configurations. Examples of well-known computing systems, environments, and/or configurations that may be suitable for use with various embodiments include, but are not limited to, embedded computing systems, personal computers, server computers, hand-held or laptop devices, multiprocessor systems, microprocessor-based systems, set top boxes, programmable consumer electronics, network PCs, minicomputers, mainframe computers, cloud services, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 12, an example system for implementing some embodiments includes a general-purpose computing device in the form of a computer 1210. Components of computer 1210 may include, but are not limited to, a processing unit 1220, a system memory 1230, and a system bus 1221 that couples various system components including the system memory to the processing unit 1220.

Computer 1210 typically includes a variety of computer readable media. Computer readable media can be any available media that can be accessed by computer 1210 and includes both volatile and nonvolatile media, and removable and non-removable media. By way of example, and not limitation, computer readable media may comprise computer storage media and communication media. Computer storage media includes both volatile and nonvolatile, and removable and non-removable media implemented in any method or technology for storage of information such as computer readable instructions, data structures, program modules or other data. Computer storage media includes, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computer 1210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer readable media.

The system memory 1230 includes computer storage media in the form of volatile and/or nonvolatile memory such as ROM 1231 and RAM 1232. A basic input/output system 1233 (BIOS), containing the basic routines that help to transfer information between elements within computer 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1237.

The computer 1210 may also include other removable/non-removable volatile/nonvolatile computer storage media. By way of example only, FIG. 12 illustrates a hard disk drive 1241 that reads from or writes to non-removable, nonvolatile magnetic media, a magnetic disk drive 1251 that reads from or writes to a removable, nonvolatile magnetic disk 1252, a flash drive reader 1257 that reads flash drive 1258, and an optical disk drive 1255 that reads from or writes to a removable, nonvolatile optical disk 1256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1241 is typically connected to the system bus 1221 through a non-removable memory interface such as interface 1240, and magnetic disk drive 1251 and optical disk drive 1255 are typically connected to the system bus 1221 by a removable memory interface, such as interface 1250.

The drives and their associated computer storage media discussed above and illustrated in FIG. 12 provide storage of computer readable instructions, data structures, program modules and other data for the computer 1210. In FIG. 12, for example, hard disk drive 1241 is illustrated as storing operating system 1244, application programs 1245, program data 1247, and other program modules 1246. Additionally, for example, non-volatile memory may include instructions to, for example, discover and configure IT device(s); the creation of device neutral user interface command(s); combinations thereof, and/or the like.

A user may enter commands and information into the computer 1210 through input devices such as a keyboard 1262, a microphone 1263, a camera 1264, and a pointing device 1261, such as a mouse, trackball or touch pad. These and other input devices are often connected to the processing unit 1220 through a user input interface 1260 that is coupled to the system bus, but may be connected by other interface and bus structures, such as a parallel port, game port or a universal serial bus (USB). A monitor 1291 or other type of display device may also be connected to the system bus 1221 via an interface, such as a video interface 1290. Other devices, such as, for example, speakers 1297, printer 1296 and network switch(es) 1298 may be connected to the system via peripheral interface 1295.

The computer 1210 is operated in a networked environment using logical connections to one or more remote computers, such as a remote computer 1280. The remote computer 1280 may be a personal computer, a hand-held device, a server, a router, a network PC, a peer device or other common network node, and typically includes many or all of the elements described above relative to the computer 1210. The logical connections depicted in FIG. 12 include a local area network (LAN) 1271 and a wide area network (WAN) 1273, but may also include other networks. Such networking environments are commonplace in offices, enterprise-wide computer networks, intranets and the Internet.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. The modem 1272, which may be internal or external, may be connected to the system bus 1221 via the user input interface 1260, or other appropriate mechanism. The modem 1272 may be wired or wireless. Examples of wireless devices may comprise, but are limited to: Wi-Fi and Bluetooth. In a networked environment, program modules depicted relative to the computer 1210, or portions thereof, may be stored in the remote memory storage device. By way of example, and not limitation, FIG. 12 illustrates remote application programs 1285 as residing on remote computer 1280. It will be appreciated that the network connections shown are exemplary and other means of establishing a communications link between the computers may be used. Additionally, for example, LAN 1271 and WAN 1273 may provide a network interface to communicate with other distributed infrastructure management device(s); with IT device(s); with users remotely accessing the User Input Interface 1260; combinations thereof, and/or the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e. hardware with a biological element) or a combination thereof, all of which are behaviorally equivalent. For example, modules may be implemented using computer hardware in combination with software routine(s) written in a computer language (Java, HTML, XML, PHP, Python, ActionScript, JavaScript, Ruby, Prolog, SQL, VBScript, Visual Basic, Perl, C, C++, Objective-C or the like). Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded systems, machines a combination thereof, and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, flash memory, memory cards, electrically erasable programmable read-only memory (EEPROM), solid state drives, optical disks, barcodes, magnetic ink characters, a combination thereof, and/or the like.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the presently described embodiments are discussed with respect to a network switch in a computing network environment. However, one skilled in the art will recognize that embodiments may be employed to other types of networks, for example, a video network environment, an audio network environment, a satellite network environment, a cellular network environment, a SCADA system, combinations thereof, and/or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1) A device comprising:
a) at least one processor;
b) a memory;
c) at least one interface configured to communicate with micro-segmenting networked devices, at least one of the micro-segmenting networked devices communicatively coupled to at least one micro-segment within a network, the network configured to communicatively couple at least two hosts; and
d) at least one non-transitory tangible machine readable medium comprising instructions configured to cause the at least one processor to perform a process comprising:
i) receiving network traffic information from at least one of the micro-segmenting network devices;
ii) generating traffic flow data from the network traffic information;
iii) augmenting network micro-segment traffic rules employing, at least in part, at least some of the traffic flow data;
iv) receiving authority to implement the rules from at least two entities each serving at least one of a multitude of roles; and
v) programming at least one of the micro-segmenting networked devices to control traffic flow within at least one micro-segment employing the network micro-segment traffic rules.

2) The device according to claim 1, wherein the network comprises at least one of the following:
a) a data network;
b) a telecommunications network;
c) a computer network;
d) an intranet;
e) the Internet;
f) a packet-switched network;
g) a wireless network'
h) a cellular network;
i) a wired network;
j) a vlan; and
k) a combination of the above.

3) The device according to claim 1, wherein the at least one interface comprises at least one of the following:
a) an Ethernet transceiver;
b) a local area network controller;
c) a wide area network controller;
d) a fiber transceiver;
e) a wireless transceiver;
f) a wired transceiver;
g) a computer bus transceiver;
h) a local bus transceiver;
i) a Wi-Fi transceiver;
j) a virtual network interface;
k) a network socket;
l) a port;
m) a computer port; and
n) a combination of the above.

4) The device according to claim 1, wherein the interface communicates comprising at least one of the following:
a) a physical layer;
b) a data link layer;
c) an Internet protocol (IP);
d) a network address; and
e) a combination of the above.

5) The device according to claim 1, wherein at least one micro-segment comprises a point to point connection between two hosts.

6) The device according to claim 1, wherein at least one micro-segment comprises at least one sub-network within the network.

7) The device according to claim 1, wherein at least one of the micro-segmenting networked devices comprise:
a) at least one network switch;
b) network micro-segment traffic rule storage configured to hold at least a subset of the micro-segment traffic rules; and
c) network micro-segment traffic rules implementation logic configured to control at least one network switch according to at least a subset of micro-segment traffic rules.

8) The device according to claim 1, wherein at least one of the micro-segmenting networked devices comprise at least one of the following:
a) a data diode;
b) a server;
c) a compute node;
d) a router;
e) a switch;
f) a firewall;
g) a load balancer;
h) a networking node;
i) a storage node;
j) a power node;
k) a cooling node;
l) a network appliance;
m) a virtual appliance;
n) a system hardware with network access; and
o) a hosted module within a system.

9) The device according to claim 1, wherein at least one of the micro-segmenting networked devices are integrated within a networking device.

10) The device according to claim 1, wherein at least one of the micro-segmenting networked devices comprise:
a) a switch; and
b) a switch control configured to control at least one of the following:
i) the duration of a switch connection;
ii) the direction of a switch connection;
iii) a host to host connection;
iv) a switch port;
v) the protocol of a switch connection;
vi) the socket port numbers used in the connection;
vii) the physical ingress and egress interfaces of the connection; and
viii) a combination of the above.

11) The device according to claim 1, wherein the traffic flow data comprises at least one of the following:
a) a destination;
b) a source;
c) a function;
d) a port number;
e) a universally unique identifier;
f) a virtual machine name;
g) a hypervisor IP address;
h) a group/community identifier;
i) a port identifier;
j) a port range identifier;
k) a serial port range;
l) a serial port identifier;
m) a hostname;
n) an internet protocol Address;
o) a protocol type;
p) a service processor type;
q) a media access control address (MAC) Address;
r) a physical ingress and egress interface identifier; and
s) a combination of the above.

12) The device according to claim 1, wherein the generating traffic flow data from the network traffic information comprises calculating at least one of the following from the traffic flow data:
a) network communication frequency information;
b) network path information;
c) network protocol information; and
d) a combination of the above.

13) The device according to claim 1, wherein the network traffic information comprises at least one of the following:
a) a destination;
b) a source;
c) a function;
d) a port number;
e) a universally unique identifier;
f) a virtual machine name;
g) a hypervisor IP address;
h) a group/community identifier;
i) a port identifier;
j) a port range identifier;
k) a serial port range;
l) a serial port identifier;
m) a hostname;
n) an internet protocol Address;
o) a protocol type;
p) a service processor type;
q) a media access control address (MAC) Address;
r) a physical ingress and egress interface identifier; and
s) a combination of the above.

14) The device according to claim 1, wherein the process further comprises logging at least one of network traffic information and traffic flow information.

15) The device according to claim 1, wherein network micro-segment traffic rules comprise at least one of the following:
a) a white list of allowable communications between at least two hosts;
b) threat indicator logic;
c) network micro-segment traffic rules modification logic;
d) an indicator of compromise (IOC);
e) an indicator of attack (IOA);
f) a temporal network micro-segment traffic rule;
g) a time limit for an untrusted device;
h) a verification rule;
i) a static rule;
j) activity rules;
k) a conditional rule
l) an adaptive rule;
m) a physical interface limiting rule; and
n) a combination of the above.

16) The device according to claim 1, wherein network micro-segment traffic rules evaluate at least one of the following:
a) duration of a communication;
b) direction of a communication;
c) a pack size;
d) packet content;
e) a watermark;
f) the frequency of communications between at least two hosts;
g) port rules;
h) threat indicator logic;
i) an indicator of compromise (IOC);
j) an indicator of attack (IOA);
k) a temporal network micro-segment traffic rules;
l) the physical ingress and egress interface identifier; and
m) a combination of the above.

17) The device according to claim 1, wherein the network micro-segment traffic rules employ at least one of AND/OR logic and temporal logic configured to compare at least two of the following rule elements:
a) a flow path;
b) a frequency of flow originating from a single source;
c) a frequency of flow destined for a single source;
d) networked device information;
e) an action source;
f) an action;
g) a physical ingress or egress interface identifier; and
h) a combination of the above.

18) The device according to claim 1, wherein the method further comprises defining at least one of the network micro-segment traffic rules employing at least one of the following:
a) a visual diagram;
b) a script;
c) a list; and
d) a combination of the above.

19) The device according to claim 1, wherein the process further comprises presenting the network micro-segment diagram employing at least one of the following:
a) a network topology;
b) a micro-segmentation network topology;
c) a network table;
d) statistics; and
e) a combination of the above.

20) The device according to claim 1, wherein the instructions are executed within a virtual machine environment acting as at least one of the following:
a) a server;
b) a compute node;
c) a router;
d) a switch;
e) a firewall;
f) a load balancer;
g) a networking node;
h) a storage node;
i) a power node;
j) a cooling node;
k) a network appliance;
l) a virtual appliance;
m) a system hardware with network access;
n) a hosted module within a system; and
o) a combination of the above.
